(19) United States
(12) Patent Application Publication
(10) Pub. No.: US 2001/0040625 A1
(43) Pub. Date: Nov. 15, 2001

(54) Digital camera capable of being collected for reuse

(76) Inventors: Hideo Okada, Uda-gun (JP); Mitsuhiro Iwata, Tenri-shi (JP)

Correspondence Address: Dike, Bronstein, Roberts & Cushman, EDWARDS & ANGELL, P O BOX 9169, BOSTON, MA, 02209, US

(21) Appl. No.: 09/727,049

(22) Filed: Nov. 30, 2000

(30) Foreign Application Priority Data
Dec. 3, 1999 (JP) 11-345078(P)
Aug. 8, 2000 (JP) 2000-239892(P)

(51) Int. Cl. H04N 5/225

(52) U.S. Cl. 348/207; 348/552; 396/6

(57) ABSTRACT

This digital camera is available at, for example, a selling store such as convenience store. After taking desired photographs, the user returns the digital camera to the selling store. The returned digital camera is collected at a prescribed distribution center, where the photographed data in the digital camera is transmitted to an image station apparatus through a transmitting apparatus. The image station apparatus stores the photographed images in a hard disk. The user accesses the image station apparatus over the Internet by using a user's personal computer, thereby viewing or downloading the images photographed with the digital camera. Thus, the digital camera that allows everybody to enjoy digital photographs at low cost can be provided.

### BACKGROUND OF THE INVENTION

1. Field of the Invention

The present invention generally relates to a digital camera. More particularly, the present invention relates to a digital camera capable of being collected for reuse, collecting system thereof, and image viewing method.

2. Description of the Background Art

Conventionally, silver-salt analog cameras have been provided as image photographing means. As such analog cameras, inexpensive cameras of “film-with-lens” type are commercially available.

In recent years, digital cameras have been increasingly placed on the market. Images photographed with the digital cameras can be stored as digital data, making it possible to process the images or transfer them over a network such as Internet. Accordingly, the digital cameras have been increasingly demanded.

Although the digital cameras have become popular for such reasons, those having a large number of pixels are required in order to obtain an image as high quality as a picture of the analog cameras. However, such digital cameras having a large number of pixels are not readily available to ordinary users because of their high price.

### SUMMARY OF THE INVENTION

It is therefore an object of the present invention to provide a digital camera that allows everybody to enjoy digital image photographs at low cost.

It is another object of the present invention to provide a digital camera collecting system.

It is a still another object of the present invention to provide a method for viewing an image photographed with the digital camera.

The above-mentioned objects of the present invention are achieved by providing a digital camera with the following elements. More specifically, a digital camera according to the present invention includes: an optical system; an image processing unit for processing an object image received through the optical system; a memory for storing the processed photographed image data; and a transmitter for transmitting the photographed image data stored in the memory to a prescribed photographed image data storage device over a network. The user can view the photographed image stored in the photographed image data storage device by accessing the photographed image data storage device over the network by using access data that is unique to each digital camera.

Since the user can view the images he/she photographed by accessing the photographed image data storage device over the network by using the access data that is unique to each digital camera, the user need not own his/her digital camera. As a result, a digital camera that allows everybody to enjoy digital photographs at low cost can be provided.

Preferably, the access data is provided to each digital camera in an invisible manner. More specifically, the access data may be provided on an outer-sheath portion of the digital camera body like a scratch card, or may be provided on, for example, a packaging film packaging the digital camera. A plurality of copies of the access data may be provided to each camera in an invisible manner, so that one can be kept by the user, and another can be kept for the photographed image data storage device.

More preferably, the access data is pre-stored in the memory. Since the access data is stored in the memory, the access data is automatically sent to the photographed image data storage device together with the digital camera body.

An identification code for specifying a selling area of the digital camera may be pre-stored in the memory, so that the photographed data can be processed in the photographed image data storage device according to information on the selling area.

According to another aspect of the invention, a digital camera collecting system collects a digital camera that stores an image of an object photographed by a user as digital data. The user buys a digital camera, and then returns the used digital camera to a collecting station. An image data station delivers the photographed image in the collected digital camera over a network. The user views the image he/she photographed by accessing the image data station over a network through a personal computer.

Since the user can view the image he/she photographed by accessing the image data station over the network, he/she can enjoy the images in the digital camera. On the other hand, the digital camera itself is collected for reuse. As a result, everybody can enjoy digital photographs at low cost, as well as an environmentally friendly digital camera collecting system can be provided.

Preferably, the digital camera has a unique access code, and the user accesses the image data station by using the access code. Since the access data for accessing the photographed image data storage device is unique to each digital camera, the images photographed by the user are not accessed by others.

Preferably, the access data is provided to each digital camera in an invisible manner. More specifically, the access data may be provided on an outer-sheath portion of the digital camera like a scratch card, or may be provided on, for example, a packaging film packaging the digital camera. A plurality of copies of the access data may be provided to each camera in an invisible manner, so that one can be kept by the user, and another can be kept for the collecting station and image data station.

More preferably, a plurality of selling stations and collecting stations are provided, the image data station is capable of delivering the photographed image to the plurality of selling stations and collecting stations, and the plurality of selling stations and collecting stations each includes a portion for displaying the delivered image data.

The image data photographed with the digital camera can be delivered over the network to the plurality of selling stations and collecting stations for display. Therefore, the user can view the images he/she photographed at a desired selling station and collecting station. As a result, those who do not have a personal computer can enjoy the digital camera.

According to a still another aspect of the present invention, a photographed image storage device transmits digital image data photographed by a user with a digital camera to a user's receiving terminal over a network as requested from the user. The photographed image storage device includes: an accepting device for accepting access from the user over the network; a determination unit for determining whether the user is a proper user or not when the accepting device accepts the access; and a transmitter for transmitting a prescribed photographed image to the user's receiving terminal as requested from the user, when the determination unit determines that the user is a proper user.

Preferably, the proper-user determination unit determines whether the digital camera has been disassembled or not.

The accepting device for accepting access from the user over the network may accept the access according to a prescribed protocol, and the proper-user determination unit may include a determination unit for determining whether the protocol is the prescribed protocol or not.

The accepting device for accepting access from the user over the network may accept access from a prescribed user's receiving terminal, and the proper-user determination unit may include a determination unit for determining whether the access is from the prescribed user's receiving terminal or not.

According to a yet another aspect of the present invention, a photographed image display device displays data photographed by a user with a digital camera by accessing a prescribed photographed image storage device on a network. The photographed image display device is provided at a store where the digital camera is available to the user, and includes: an access unit for accessing the photographed image storage device over the network by using access data that is unique to each digital camera; an introducing unit for introducing a photographed image as desired by the user from the photographed image storage device over the network; and a display device for displaying the desired photographed image introduced by the introducing unit.

According to a yet another aspect of the invention, a method for viewing an image includes the steps of: causing a user to use a digital camera for storing an image as digital data; collecting the used digital camera; storing an photographed image of the collected digital camera in a prescribed image storage device on a network; and viewing the photographed image by the user by accessing the image storage device over the network by using access data that is unique to each digital camera.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIGS. 1A and 1B are perspective views showing external appearance of a digital camera.

FIGS. 2A and 2B are schematic diagrams showing an internal structure of the digital camera.

FIGS. 3A to 3C are schematic diagrams showing an external structure of the digital camera.

FIG. 4 is a block diagram showing a main part of the digital camera.

FIG. 5 is a schematic diagram showing the overall configuration of a digital camera collecting system to which the present invention is applied.

FIG. 6 is a schematic diagram illustrating an image data flow in the digital camera collecting system to which the present invention is applied.

FIG. 7 is a schematic diagram showing connection between a transmitting apparatus and digital camera.

FIGS. 8A and 8B are diagrams showing the display upon accessing an image station apparatus.

FIG. 9 is a diagram showing displayed photographed images.

FIG. 10 is a diagram showing the display screen of a photo processing service.

FIGS. 11A to 11D are schematic diagrams showing memories of a digital camera provided with a separate memory having a URL (Uniform Resource Locator) and password.

### DESCRIPTION OF THE PREFERRED EMBODIMENTS

Hereinafter, an embodiment of the present invention will be described with reference to the accompanying drawings.

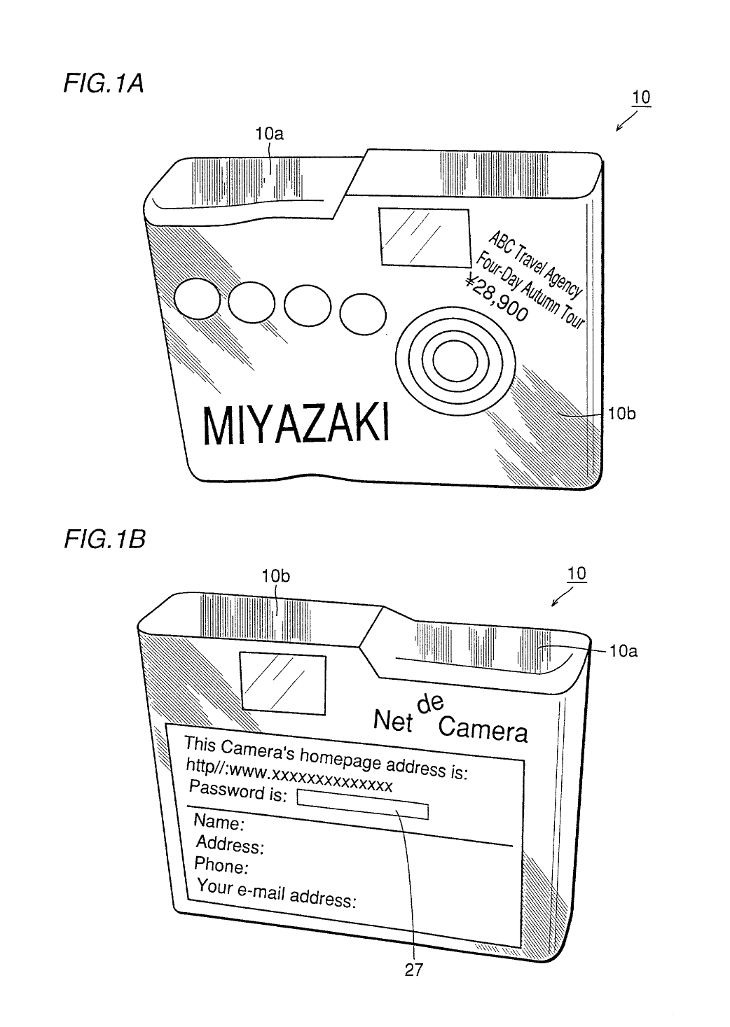

Referring to FIG. 1A, a digital camera 10 includes a camera body 10a and an outer-sheath portion 10b covering the camera body 10a. Referring to FIG. 1A, the name of a tourist site, for example, may be displayed on the front of the outer-sheath portion 10b for advertisement.

In the present invention, images photographed with the digital camera 10 are viewed by accessing a predetermined URL (Uniform Resource Locator) over a network such as Internet after returning the used digital camera 10, as described later in detail.

Referring to FIG. 1B, URL and password 27 for accessing the photographed images are displayed on the back of the digital camera 10. Note that each digital camera 10 has a different password 27, and the password 27 is recorded on the outer-sheath portion 10b of the digital camera 10 in an invisible manner like, e.g., a scratch card. The scratch portion recording the password may be of a duplicate type, so that one can be kept by the user when returning the digital camera 10, and the other attached to the digital camera 10 can be kept by the side collecting the digital camera 10 as described later.

Note that a caution against disassembling the camera may be printed on top of the outer-sheath portion 10b of the digital camera 10. Processing such as erasing the stored data in a built-in memory 18 is conducted if the digital camera 10 is disassembled. Therefore, such a caution is displayed as preventive measures thereof.

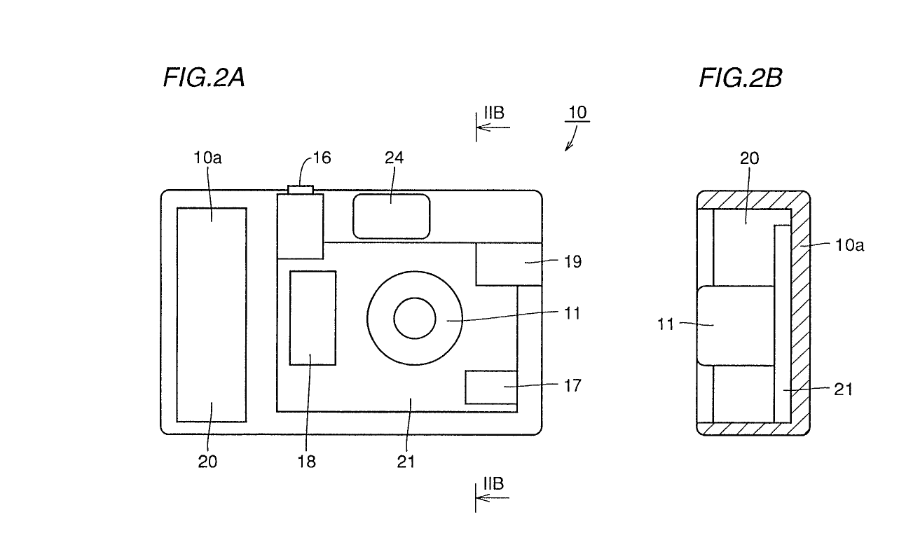

FIGS. 2A and 2B are schematic diagrams showing an internal structure of the digital camera 10 of FIG. 1. FIG. 2A is a front view, and FIG. 2B is a cross-sectional view taken along the line IIB-IIB of FIG. 2A. Referring to FIGS. 2A and 2B, the digital camera 10 includes a lens 11 for photographing an object, a viewfinder 24 for checking the object to be photographed, a shutter 16, a phototransistor 17 for sensing whether the digital camera 10 has been disassembled or not based on incident light, a flash memory 18 for storing a photographed image, and a battery 20 serving as a driving source of the digital camera 10. The battery 20 can be easily removed and replaced with a new one by removing the outer-sheath portion 10b. The digital camera 10 is provided with a transmitting terminal 19 that is described later.

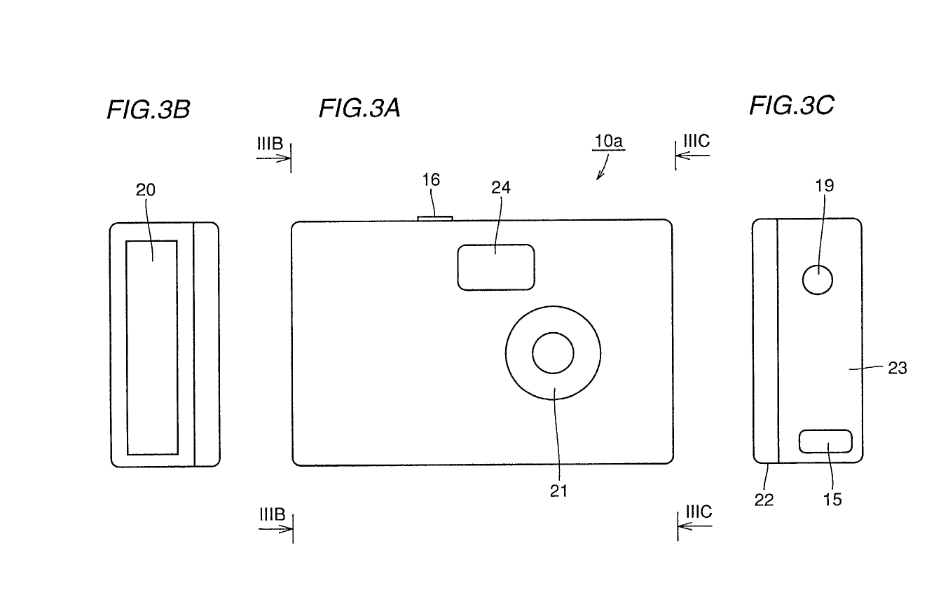

FIGS. 3A to 3C are schematic diagrams showing external appearance of the digital camera 10. FIG. 3A is a front view of the digital camera body 10a, FIG. 3B is a left side view along the line IIIB-IIIB of FIG. 3A, and FIG. 3C is a right side view along the line IIIC-IIIC of FIG. 3A. The digital camera 10 is formed by engaging an upper cabinet 22 provided with the lens 11 with a lower cabinet 23 having the URL and the like displayed thereon. A main switch 15 for starting the operation of the digital camera 10 and the transmitting terminal 19 are provided on the right side of the digital camera body 10a.

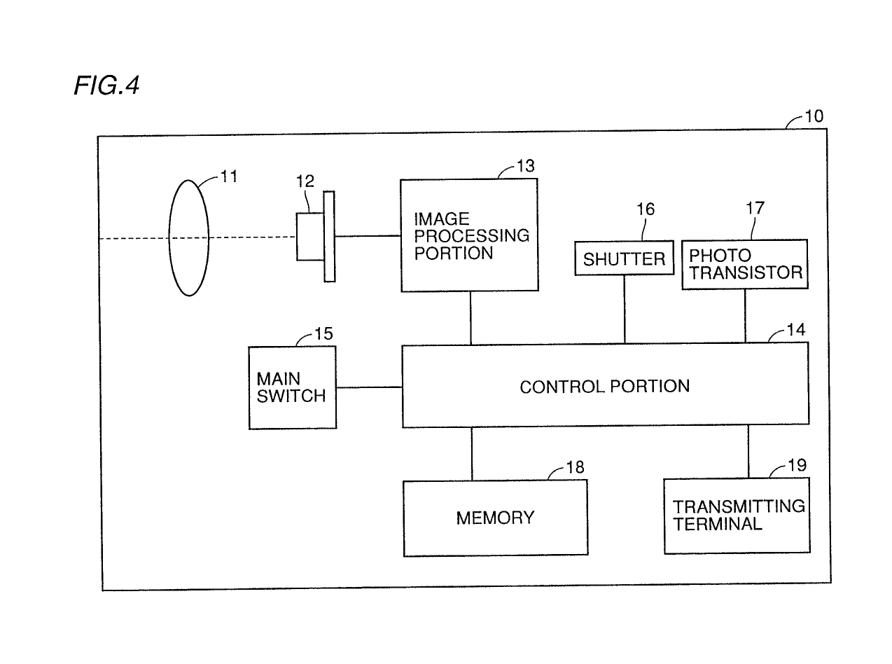

FIG. 4 is a block diagram showing a main part of the digital camera 10. Referring to FIG. 4, the digital camera 10 includes a CCD (Charge Coupled Device) 12 for photographing an object image incident through the lens 11, an image processing portion 13 connected to the CCD 12 for processing the photographed image data, a control portion 14 for controlling the whole digital camera 10, the shutter 16, the phototransistor 17, the main switch 15, the memory 18 and the transmitting terminal 19.

Herein, the CCD 12 has 680,000 pixels, and the memory 18 is a 4-MB flash memory. However, specification of the digital camera 10 is not limited to this, and the digital camera 10 may have any desired specification.

Hereinafter, the control flow of the digital camera 10 will be described. First, the digital camera 10 enters the standby mode in response to turning-on of the main switch 15. The standby mode is a state in which the digital camera 10 is ready to obtain an image, and in this mode, the battery 20 supplies power to the CCD 12, shutter 16, image processing portion 13, memory 18 and control portion 14 which are required to obtain an image. An image is photographed in response to turning-on of the shutter 16 in this state.

The photographed image data of a not-shown object is recorded on the memory 18 through the lens 11, CCD 12, image processing portion 13 and control portion 14. This image is stored in the memory 18 in a JPEG (Joint Photographic Expert Group)-compressed form.

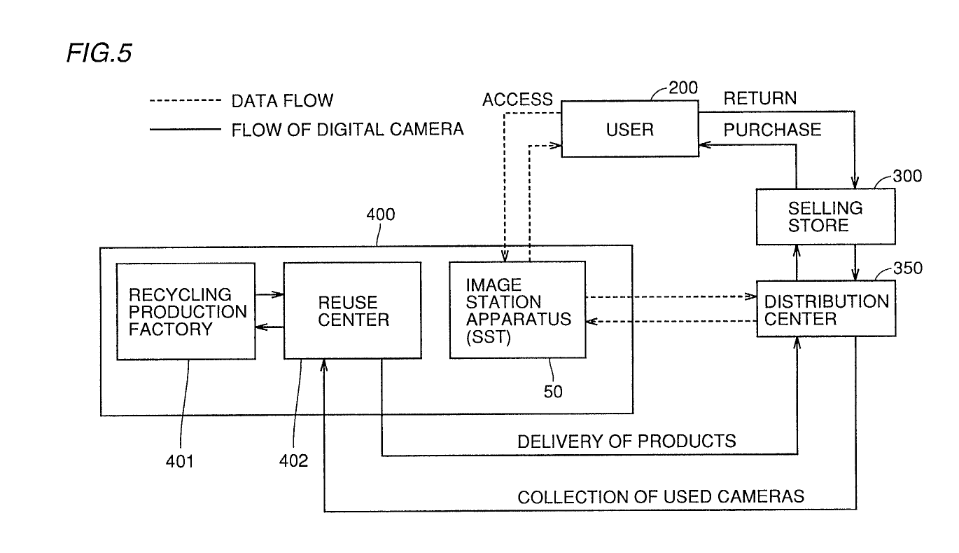

FIG. 5 is a schematic diagram illustrating a distribution/service system of the digital camera 10 according to the present invention. Referring to FIG. 5, the solid lines indicate the flow of the digital camera 10, and the dotted lines indicate the flow of the image data photographed by the user.

Referring to FIG. 5, a user 200 buys a digital camera 10 at, for example, a store 300 selling the digital camera 10 such as convenience store. It is herein assumed that there are a plurality of selling stores 300. The user 200 returns the used digital camera 10 to the store 300 he/she bought it or another store 300 such as convenience store. At this time, the user 200 receives a duplicate of the display portion showing thereon a password and address at which the photographed images are available, i.e., the portion provided on the back of the outer-sheath portion 10b of the digital camera 10. The returned digital camera 10 is collected at a distribution center 350. The outer-sheath portion 10b is first removed from the collected digital camera 10. Then, the digital camera 10 is electrically connected to a transmitting terminal of the distribution center 350, so that the photographed image data is transmitted to the server of an image station 50. For example, this image station 50 may be Sharp Space Town (hereinafter, referred to as SST), Sharp Corporation's Internet homepage.

It is herein assumed that the image station 50 is set so that it can receive the image data according to a predetermined communication protocol.

A proper distribution center 350 transmits image data according to a correct communication protocol. Therefore, when the proper distribution center 350 transmits image data, a flag such as fraudulent connection as described later is not set. The user can receive a service as described below at the image station 50 such as STT. Thus, the user can view and download the photographed images.

After transmission of the images, the digital camera body 10a is collected at a reuse center 402 of a manufacturer of the digital camera 10 (e.g., Sharp Corporation), and sent to a recycling production factory 401. In the recycling production factory 401, the battery 20, external appearance, basic camera function of the digital camera body 10a, lens 11 and the like are examined, and the data stored in the memory 18 is cleared. Then, the outer-sheath portion 10b is replaced with a new one, and a new password is recorded. Thus, the resultant digital camera 10 is shipped again.

If failed the examination, the digital camera body 10a is disassembled, and the upper and lower cabinets 22 and 23 are recycled. Reusable components (such as CCD 12, shutter 16 and substrate 21) are examined and washed for reuse.

The shipped digital camera 10 is sent to the store 300 such as convenience store through the reuse center 402 and distribution center 350.

Note that the store 300 such as convenience store may also serve as distribution center 350.

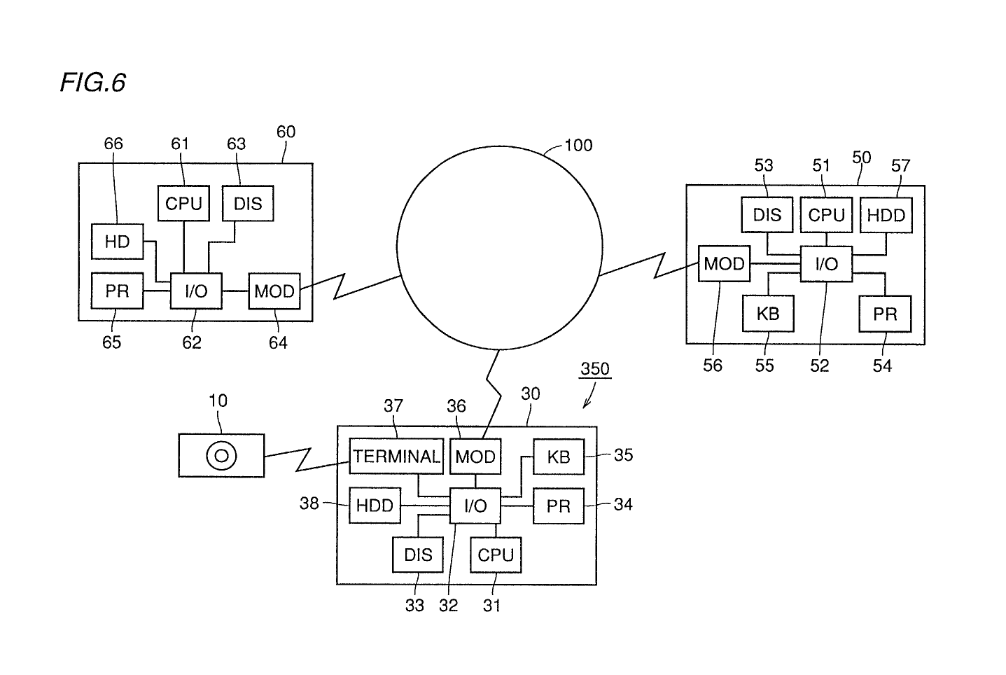

Hereinafter, a specific image data flow will be described. FIG. 6 is a schematic diagram showing the specific image data flow.

Referring to FIG. 6, the distribution center 350 serving as a collecting center of the digital camera 10 is provided with a transmitting apparatus 30. The transmitting apparatus 30 is an apparatus for transmitting image data photographed by the user with the digital camera 10 to the image station 50 such as SST over a network 100 such as Internet.

After receiving the returned digital camera 10, the distribution center 350 transmits the image data to the image station apparatus 50 through the transmitting apparatus 30.

The transmitting apparatus 30 includes a terminal portion 37 connected to the digital camera 10 for receiving images from the digital camera 10, a modem 36 for transmitting the image data received through the terminal portion 37 to the image station apparatus 50 over the network 100, a hard disk 38 for temporarily storing the image data photographed with the digital camera 10, and a CPU (Central Processing Unit) 31 for controlling the whole transmitting apparatus 30. The transmitting apparatus 30 includes a regular keyboard 35, a display portion 33 and a printer 34 in addition to the above-mentioned elements. These elements are connected to each other through an I/O (Input/Output) interface 32.

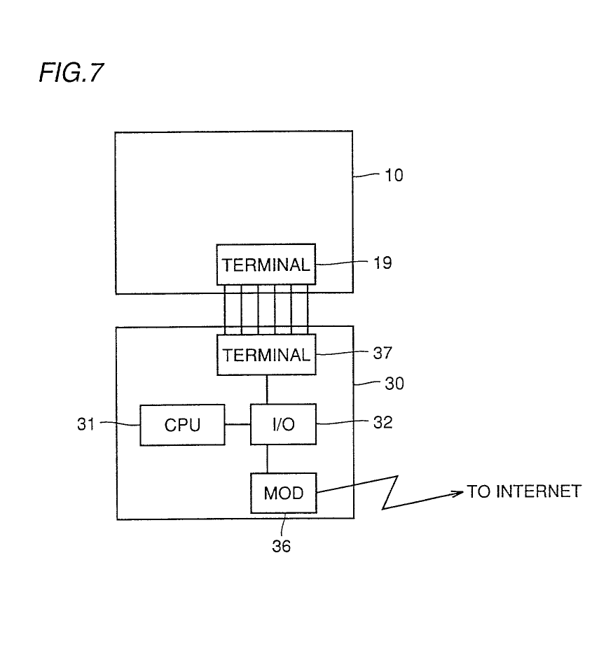

FIG. 7 is a schematic diagram showing connection between the digital camera 10 and transmitting apparatus 30. Referring to FIG. 7, the transmitting terminal 19 of the digital camera 10 is electrically connected to the terminal portion 37 of the transmitting apparatus 30. Through this connection, the photographed data stored in the memory 18 of the digital camera 10 is transmitted to the image station apparatus 50 over the network 100. Note that the elements of the transmitting apparatus 30 that are not significantly involved in image transmission are omitted in FIG. 7.

The following data is transmitted from the digital camera 10 to the transmitting apparatus 30: date and time of transmission, transmitter's name, transmitting store's name, number of the digital camera 10 (which is the same as a homepage address at which the photographed images are available), password (which is a number corresponding to the homepage address), and data indicating the order of individual images. Note that this data is not limited to image data. In the case where voice or the like is recorded during photographing, voice data or the like may be transmitted.

Flag information may be transmitted. The flag information as used herein refers to information of a selling-area identification code, fraudulent disassembly flag, fraudulent connection flag, information on the history of usage and the like. The selling-area identification code as used herein refers to a code having information on a selling area of the digital camera 10. The fraudulent disassembly flag as used herein refers to a flag that is set in response to the user's fraudulent disassembly of the digital camera 10, and the fraudulent connection flag refers to a flag that is set in response to the user's fraudulent connection. The information on the history of usage as used herein includes a power-supply period of the battery and the number of photographed images. These flags will be described later in detail.

Referring back to FIG. 6, the image station apparatus 50 will now be described. The image station apparatus 50 includes a CPU 51 for controlling the whole image station apparatus 50, a modem 56 for transmitting and receiving data to and from the network 100, a display portion 53, a keyboard 55, a printer 54, a hard disk 57 for storing the image data received over the network 100, and an I/O interface 52 for connecting these elements to each other.

The image station apparatus 50 receives the image data photographed with the digital camera 10 over the Internet, and stores the received data in the hard disk 57 at a prescribed address in connection with the password of the digital camera 10.

Note that the image data photographed with the digital camera 10 may be stored in the hard disk 38 of the transmitting apparatus 30 so as to be displayed on the display portion 33 as requested from the user who bought the digital camera 10, and printed with the printer 34 as required.

The image station apparatus 50 includes the display portion 53 and printer 54. Therefore, the images may be displayed on the display portion 53 and printed with the printer 54 as requested from the user when visiting the image station apparatus 50.

Hereinafter, a method for viewing an image photographed by the user with the digital camera 10 that he/she bought will be described.

Referring to FIG. 6, the user accesses the image station apparatus 50 by using a user's personal computer 60 connected to the network 100, in order to view the images he/she photographed.

The user's personal computer 60 includes a CPU 61 for controlling the whole personal computer 60, a display portion 63, a modem 64 for connecting to the network 100, a printer 65, a storage device 66 such as hard disk, and an I/O interface 62 for connecting these elements to each other.

The user accesses the image station apparatus 50 by designating a URL on the network 100 such as Internet through the user's personal computer 60.

It is now assumed that the user knows the URL and password of the homepage address of the image station apparatus 50 as described in connection with FIG. 1B by scratching when he/she returned the digital camera 10 to the store 300 such as a convenience store.

Note that an apparatus for the user to access the image station apparatus 50 is not limited to the user's personal computer 60, and may be a mobile-phone device capable of displaying an image such as cellular phone and PHS (Personal Handyphone System). In this case, the printer 65 may be eliminated, and the hard disk 66 may be replaced with a semiconductor memory. Alternatively, a PDA (Personal Digital Assistant) and the like may be used. In this case as well, the basic structure is the same as that of the user's personal computer 60 shown in FIG. 6, but the printer 65 may be eliminated, and the hard disk 66 may be replaced with a semiconductor memory.

Alternatively, a word processor with a built-in modem and the like may be used. In this case as well, the basic structure is the same as that of the user's personal computer 60, but the hard disk 66 may be replaced with a semiconductor memory.

Alternatively, a modem may be integrated into the digital camera 10. In this case as well, the basic structure is the same as that of the user's personal computer 60, but the printer 65 may be eliminated, and the hard disk 66 may be replaced with a semiconductor memory.

Alternatively, the user's personal computer 60 may be replaced with a facsimile apparatus. In this case, the facsimile apparatus is used to access the image station apparatus 50 over the network 100, and the images are printed with a printing function of the facsimile apparatus. It should be understood that the facsimile apparatus may be a color facsimile apparatus.

Alternatively, the user's personal computer 60 may be replaced with a television capable of connecting to the Internet. In this case as well, the basic structure is the same as that of the user's personal computer 60, but the printer 65 may be eliminated.

Alternatively, another digital information appliance capable of connecting to the Internet may be used to access the image station apparatus 50. Such a digital information appliance includes, for example, a microwave oven, air conditioner, washing machine and refrigerator capable of connecting to the Internet.

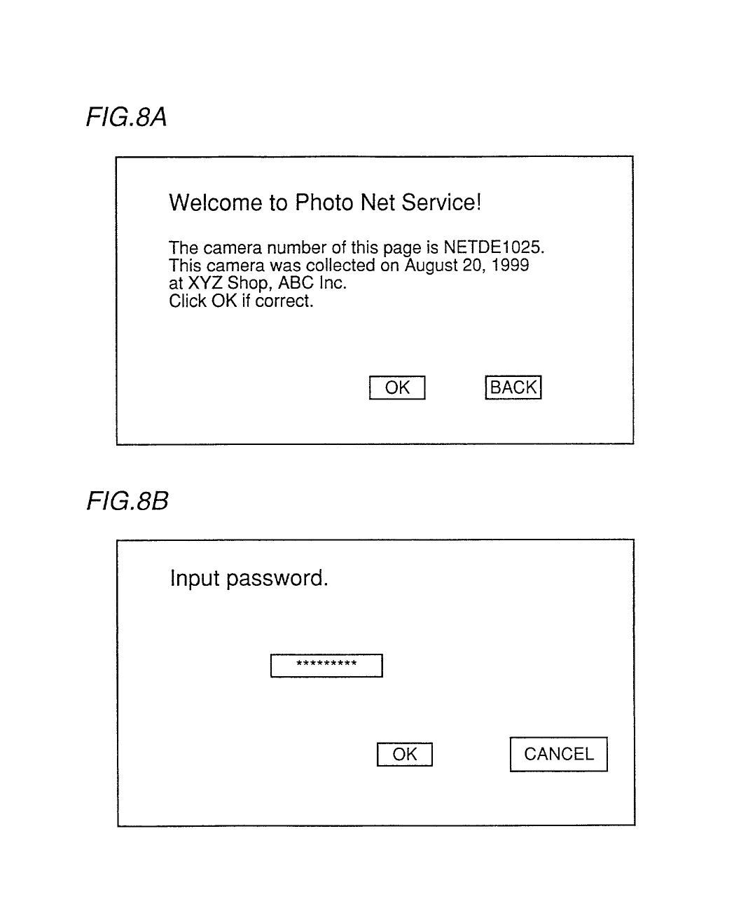

FIGS. 8A and 8B are diagrams showing a display on the display portion 63 of the user's personal computer 60 upon accessing the Internet using the above-mentioned data. FIG. 8A shows the display upon accessing the image station apparatus 50. As shown in FIG. 8A, such an image display service for the digital cameras suitable for collection is herein referred to as photo net service. When the user accesses the image station apparatus 50 by using the user's personal computer 60, specific data such as collecting date and store of the camera is displayed. The user clicks OK on the screen if the contents displayed on the screen correspond to the digital camera 10 that he/she used. Then, the display of FIG. 8B appears on the screen. The user inputs a password as described earlier, and then clicks OK.

If the input password is correct, the image station apparatus 50 accesses the hard disk 57 at a specific address stored in connection with the password, and displays the image data stored at the address on the display portion 63 of the user's personal computer 60 over the network 100.

When the user accesses the Internet, the list of photographed images is displayed. In this state, the user can proceed to various services such as editing and downloading of the photographed images and image synthesis service.

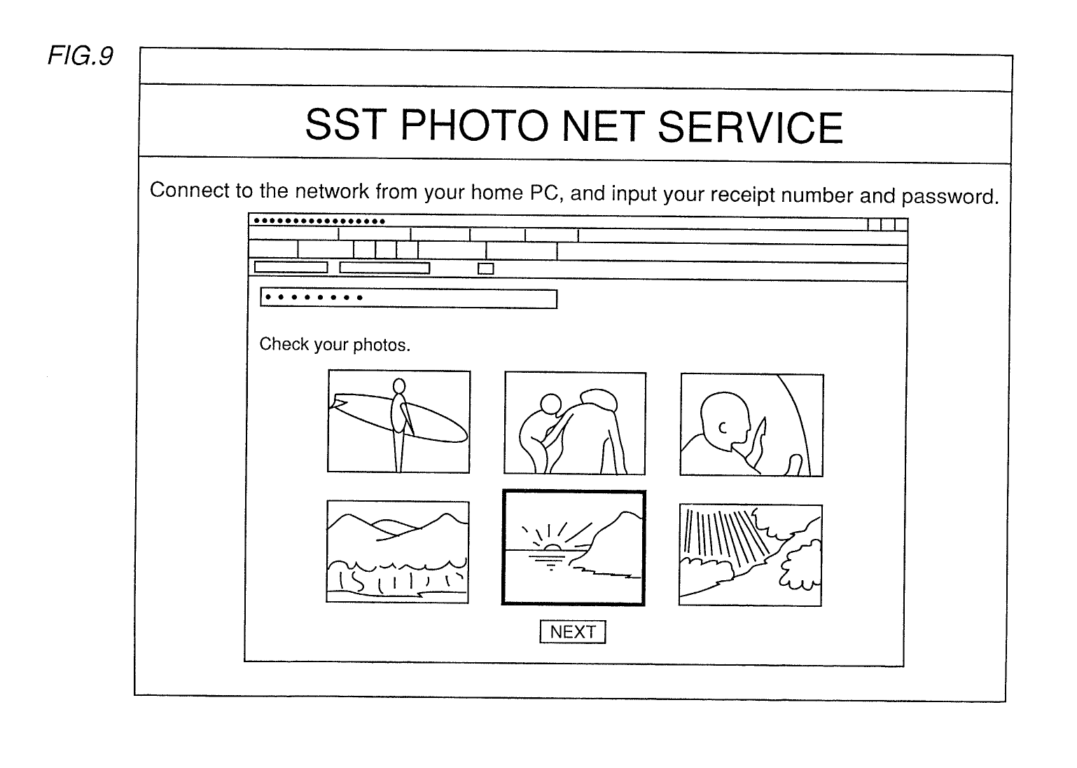

FIG. 9 is a diagram showing an exemplary display of the photographs on the display portion 63 of the user's personal computer 60 when the input password is correct.

As shown in FIG. 9, a plurality of images are sequentially displayed on the screen. Note that enlargement/reduction of the image and another desired image processing may be conducted by clicking an image of interest.

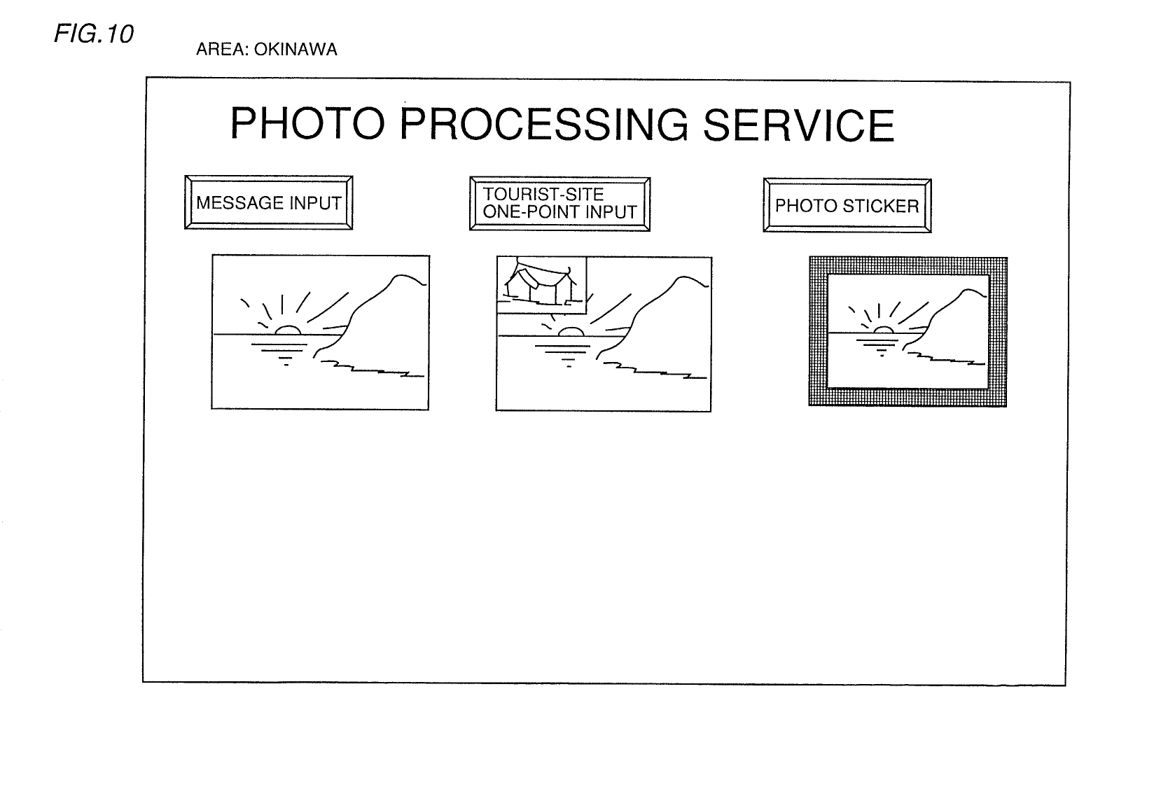

FIG. 10 is a diagram showing an exemplary screen displaying such a photo-processing service. For example, as shown in FIG. 10, message input and tourist-site one-point input can be made to each photograph, and also, a photo sticker can be made based on the photograph.

Note that tourist-site one-point input as used herein refers to a service to display a tourist site on a part of the photographed image. More specifically, the digital camera 10 that the user purchased has pre-stored information on the purchase place in the memory 18, so that the purchase place can be specified from the pre-stored information in the memory 18. Thus, a famous tourist site in that area is displayed on a part of the photographed image.

Hereinafter, fraud prevention will be described. This is the operation conducted in the control portion 14 of FIG. 4 when the user has fraudulently disassembled the digital camera. The control portion 14 conducts the following processing in response to the user's fraudulent disassembly:

(1) The phototransistor (which may be a photo-interpreter) 17 senses the user's fraudulent disassembly by sensing the outside light, thereby erasing the photographed data stored in the memory 18.

(2) The phototransistor 17 senses the user's fraudulent disassembly by sensing the outside light, thereby setting a fraudulent disassembly flag on the memory 18. This flag is sent as information during data transmission to the transmitting apparatus. This data is used to warn or charge the user against his/her misuse. This processing may be conducted at the distribution center 350 provided with the transmitting apparatus 30, or may be conducted when the user accesses the image station apparatus 50.

Hereinafter, another example of fraud prevention will be described. This is the operation conducted in the control portion 14 when the user has fraudulently connected the digital camera 10.

In this case, the following control is conducted:

(1) When a communication error such as failing to connect to a proper transmitting terminal or failing to connect according to a proper communication protocol, the data stored in the memory 18 is erased.

(2) Upon failing to connect to a proper transmitting terminal or failing to connect according to a proper communication protocol, a fraudulent connection flag is set on the memory 18 so as to be transmitted as information during image transmission.

Such information is used to warn or charge the user against his/her fraudulent connection as described above.

Note that the scratch-type password is not necessarily provided on the outer-sheath portion 10b of the digital camera 10. The password may be provided on, for example, a not-shown packaging film packaging the digital camera 10 when the user buys the digital camera 10. Alternatively, the password may be provided both on the packaging film and outer-sheath portion 10b of the digital camera 10, so that one on the digital camera 10 can be kept by the store receiving the returned digital camera 10, whereas the other on the packaging film can be kept by the user.

In the above-described embodiment, the password and URL are provided on the outer-sheath portion of the digital camera 10. However, the present invention is not limited to this. A separate memory having a URL and password may be provided to the digital camera 10 so that the memory can be given to the user.

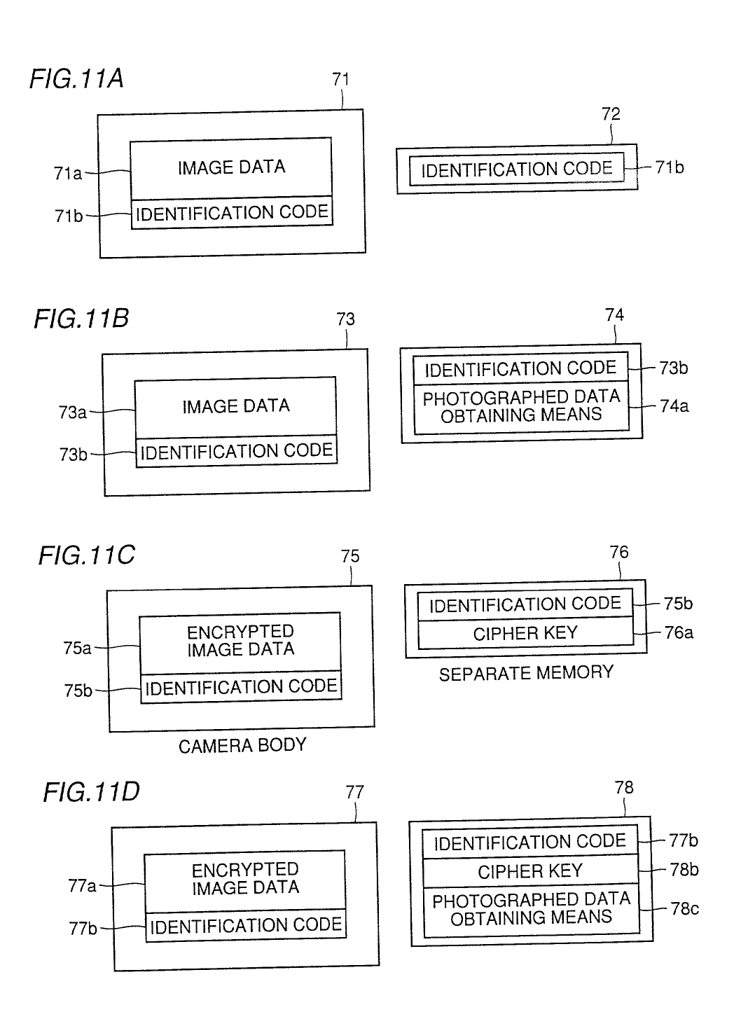

A specific embodiment thereof will now be described with reference to FIGS. 11A to 11D.

FIG. 11 is a diagram showing a memory 71 integrated into the digital camera 10 (corresponding to the memory 18 of FIG. 4) and a memory card 72 that is a separate memory. It is herein assumed that both memories are connected to the control portion 14 of the digital camera 10 in a manner similar to that of FIG. 4, and only the memory card 72 is detachable.

Referring to FIG. 11A, in the present embodiment, the digital camera 10 includes the memory 71 storing photographed image data 71a and an identification code 71b for identifying the digital camera 10. The memory card 72 separate from the memory 71 of the digital camera 10 stores the identification code 71b. This identification code 71b is preferably secret to the user as well.

When returning the digital camera 10, the user receives the memory card 72 together with a prescribed URL. Then, the user accesses the prescribed URL, and reads the memory card 72 with a not-shown memory card reader of the user's personal computer 60 connected to the network. As a result, the user can automatically connect to the image station apparatus 50 to obtain the data photographed with his/her digital camera.

FIG. 11B is a diagram showing another embodiment. In this embodiment, a memory 73 of the digital camera 10 stores photographed image data 73a and an identification code 73b for identifying an individual digital camera 10. A memory card 74 stores means (including URL, password and the like) 74a for obtaining photographed data, and identification code 73b. This identification code 73b is preferably secret to the user as well.

When returning the digital camera 10, the user receives the memory card 74. Then, the user reads the memory card 74 with a not-shown memory card reader of the user's personal computer 60 connected to the network. As a result, the user can automatically connect to the image station apparatus 50 to obtain the photographed data.

FIG. 11C is a diagram showing a still another embodiment. In this embodiment, a memory 75 stores image data 75a encrypted with a known cipher key, and an identification code 75b for identifying an individual digital camera 10. A memory card 76 stores the identification code 75b and cipher key 76a. In this case, the identification code 75b may be made public, but the cipher key 76a is preferably secret to the user as well.

When returning the digital camera 10, the user receives the memory card 76 together with a prescribed URL. Then, the user connects to the prescribed URL, and reads the memory card 76 with a not-shown memory card reader of the user's personal computer 60 connected to the network. As a result, the user can automatically connect to the image station apparatus 50 to obtain the data photographed with his/her digital camera.

FIG. 11D is a diagram showing a yet another embodiment. In this embodiment, a memory 77 of the digital camera 10 stores image data 77a encrypted with a cipher key, and an identification code 77b for identifying an individual digital camera 10. A memory card 78 stores the identification code 77b, cipher key 78b, and means (including URL, password and the like) 78c for obtaining photographed data. The identification code 77b is preferably secret to the user as well.

When returning the digital camera 10, the user receives the memory card 78. Then, the user reads the memory card 78 with a not-shown memory card reader of the user's personal computer 60 connected to the network. As a result, the user can automatically connect to the image station apparatus 50 to obtain the photographed data.

Note that the memory cards 72, 74, 76 and 78 may be a magnetic tape, magnetic disk, optical disk, magneto-optical disk, semiconductor memory, barcode or the like.

By providing such a separate memory in addition to the memory of the body, the user no longer needs to memorize such an identification code and cipher key, and also, the identification code and cipher key are not easily known to others.

The user need not have an apparatus for obtaining the photographed data. Even if the user has one, the user need not conduct an operation such as connecting to the network by himself/herself.

Moreover, the encrypted photographed data eliminates the possibility that the photographed data is viewed by someone else even if the identification data is made public or the secret identification data is known to others.

The password and URL are not limited to those described above, and the user may give his/her e-mail address to the selling store when returning the digital camera, in order to receive the password and URL by e-mail. Alternatively, the user may receive his/her own identification number from the store in some way (e.g., a card having his/her identification number thereon) when returning the digital camera, and then, call a prescribed telephone center or the like and tell the identification number to obtain the URL or password or both.

For the purpose of energy saving, the operation-waiting time of the shutter 16 may be counted so as to turn off the main switch 15 automatically after a prescribed time period.

For the users who do not have a personal computer, printer and the like, an image display device capable of connecting to the image station 50 may be installed at the distribution center 350 and selling stores 300 such as convenience stores for selling and collecting the digital camera 10, so that the image station 50 may deliver the data thereto.

In this case, the image station 50 can deliver the images to any image display device. Therefore, the user can view the images on the image display device located at a desired distribution center 350 or selling store 300 such as convenience store. Accordingly, in the case where the user bought a digital camera, photographed and returned it while traveling, the user can view the photographed images at the distribution center 350 or store 300 such as convenience store located near his/her house.

Note that the digital camera is exemplarily described in the above embodiments. However, the present invention is not limited to this, and a digital video camera may be used.

Although the present invention has been described and illustrated in detail, it is clearly understood that the same is by way of illustration and example only and is not to be taken by way of limitation, the sprit and scope of the present invention being limited only by the terms of the appended claims.

What is claimed is:

1. A digital camera, comprising:
an optical system;
an image processing unit for processing an object image received through the optical system;
a memory for storing the processed photographed image data; and
a transmitter for transmitting the photographed image data stored in the memory to a prescribed photographed image data storage device over a network, wherein
the photographed image stored in the photographed image data storage device can be viewed by accessing the photographed image data storage device over the network by using access data that is unique to each digital camera.

2. The digital camera according to claim 1, wherein the access data is provided to each digital camera in an invisible manner.

3. The digital camera according to claim 2, wherein a plurality of copies of the access data are provided to each digital camera in an invisible manner.

4. The digital camera according to claim 1, wherein the access data is pre-stored in the memory.

5. The digital camera according to claim 1, wherein the memory stores an identification code for specifying a selling area of the digital camera.

6. A digital camera collecting system for collecting a digital camera that stores an image of an object photographed by a user as digital data, comprising:
a selling station for selling the digital camera;
a collecting station for collecting the sold digital camera;
an image data station for delivering the photographed image in the collected digital camera over a network; and
a personal computer capable of connecting to the image data station over the network, wherein
the user who bought the digital camera views the photographed image by accessing the image data station through the personal computer.

7. The digital camera collecting system according to claim 6, wherein the digital camera has a unique access code, and the user accesses the image data station by using the access code.

8. The digital camera collecting system according to claim 7, wherein the unique access code is provided to the digital camera in an invisible manner.

9. The digital camera collecting system according to claim 6, wherein a plurality of selling stations and collecting stations are provided, the image data station is capable of delivering the photographed image to the plurality of selling stations and collecting stations, and the plurality of selling stations and collecting stations each includes a display device for displaying the delivered image.

10. An information terminal device for accessing over a network an image data storage device that stores prescribed image data, the prescribed image data being an image photographed by a user with a digital camera, the terminal device comprising:
an access unit for accessing the image data storage device over the network by using access data that is unique to each digital camera;
an introducing unit for introducing a desired image from the image data storage device; and
a display device for displaying the image introduced by the introducing unit.

11. A photographed image storage device for transmitting digital image data photographed by a user with a digital camera to a user's receiving terminal over a network as requested from the user, comprising:
an accepting device for accepting access from the user over the network;
a determination unit for determining whether the user is a proper user or not when the accepting device accepts the access; and
a transmitter for transmitting a prescribed photographed image to the user's receiving terminal as requested from the user, when the determination unit determines that the user is a proper user.

12. The photographed image storage device according to claim 11, wherein the determination unit includes a determination unit for determining whether the digital camera has been disassembled or not.

13. The photographed image storage device according to claim 11, wherein the accepting device for accepting access from the user over the network accepts the access according to a prescribed protocol, and the determination unit includes a determination unit for determining whether the protocol is the prescribed protocol or not.

14. The photographed image storage device according to claim 11, wherein the accepting device for accepting access from the user over the network accepts access from a prescribed user's receiving terminal, and the determination unit includes a determination unit for determining whether the access is from the prescribed user's receiving terminal or not.

15. A photographed image display device for displaying data photographed by a user with a digital camera by accessing a prescribed photographed image storage device on a network, the photographed image display device being provided at a store where the digital camera is available to the user, the photographed image display device comprising:
an access unit for accessing the photographed image storage device over the network by using access data that is unique to each digital camera;
an introducing unit for introducing a photographed image as desired by the user from the photographed image storage device over the network; and
a display device for displaying the desired photographed image introduced by the introducing unit.

16. A method for viewing an image, comprising the steps of:
causing a user to use a digital camera for storing an image as digital data;
collecting the used digital camera;
storing a photographed image of the collected digital camera in a prescribed image storage device on a network; and
viewing the photographed image by the user by accessing the image storage device over the network by using access data that is unique to each digital camera.
